(19) United States
(12) Patent Application Publication
(10) Pub. No.: US 2023/0256667 A1
(43) Pub. Date: Aug. 17, 2023

(54) COMPLIANT SUPPORT STRUCTURE FOR SUBSTRATUM USED IN PHOTOPOLYMERIZATION VAT

(71) Applicant: Nexa3D Inc., Ventura, CA (US)

(72) Inventor: Izhar Medalsy, Ventura, CA (US)

(21) Appl. No.: 17/650,795

(22) Filed: Feb. 11, 2022

(51) Int. Cl. B29C 64/124; B33Y 10/00; B33Y 30/00; B29C 64/255

(52) U.S. Cl. CPC B29C 64/124; B33Y 10/00; B33Y 30/00; B29C 64/255

(57) ABSTRACT

A compliant support structure for a substratum (e.g., a membrane) used in a photopolymerization vat for 3D printing of articles by means of photo-curing photo-sensitive materials. Three-dimensional objects form by growth, due to progressive curing of a photo-curing liquid polymer within the vat, in a space between a transparent base and an extraction plate. On the side of the transparent base facing towards the photo-curing liquid polymer, a membrane is arranged, said membrane being transparent to said radiation and being supported at its edges by a compliant support structure. The compliant support structure is flexible, allowing it to bend or flex, thereby accommodating displacement of the membrane during formation of the three-dimensional objects when the extraction plate is raised.

### FIELD OF THE INVENTION

The present invention relates to the field of three-dimensional printing, commonly referred to as 3D printing, and in particular to a compliant support structure for a substratum (e.g., a membrane) used in a photopolymerization vat for 3D printing of articles by means of photo-curing photo-sensitive materials.

### BACKGROUND

Historically, within the field of 3D printing technology the formation of 3D objects through photo-curing of photo-sensitive materials involved two basic technologies: stereolithographic (“SLA”) printing, in which a laser emitting light of approximately 400 nm wavelength is used to solidify, by means of the beam emitted, a liquid, photo-curing polymer which is in a special tank; and digital light processing (“DLP”) printing, according to which a photo-curing polymer, again in a liquid state in a tank, is exposed to luminous radiation emitted by a device similar to a projector. According to both these technologies, the printing process proceeds in a bottom-up style by making one layer after another; that is, solidifying a first layer adhering to a supporting plate (or extraction plate), and then a second layer adhering to the first layer, and so on, until formation of the entire object is complete. Therefore, according to these technologies, the data representing the 3D object to be formed is organised as a series two-dimensional layers which represent transversal sections of the object. More recently, masked SLA (“MSLA”) printers in which the layers to be printed are defined using a mask, such as a liquid crystal display (LCD) screen, imposed between an ultraviolet light source and the tank containing the photo-curing polymer have been produced.

In SLA, DLP, and MSLA printers, as each layer of the object under construction is printed, the extraction plate is raised to allow a new layer of the object to be formed. Generally, these extraction plates consist of a material which facilitates the gluing on itself of the first layer of photo-cured polymer. In brief, the extraction plate moves to a predetermined distance from where the first layer of the object will be formed in the tank of photo-sensitive material (the so-called “resin”), and waits for a light source to solidify the first layer. The extraction plate is then raised by a distance sufficient for the layer just formed to detach from the base of the tank (usually approx. 1 mm) and then lowers by the same distance less the predetermined distance for the formation of the second layer. This process continues until the entire object is formed. In order to avoid tearing of the newly-formed layers of the object during the raising of the extraction plate the extraction plate may be tilted during the process to assist the layer just formed to detach from the base of the tank (typically, a transparent base that allows the passage of ultra-violet (UV) light for triggering the photo-curing process, e.g., quartz or borosilicate glass). This tilting movement has an associated time, which must take into account the time for the extraction plate to rise and lower and for the renewal or refreshing of the viscous resin in the printing region. Alternatively, or in addition to the tilting of the extraction plate, the printers may employ a non-stick coating on the inside surface of the base of the tank to allow the layers of cured polymer to more readily detach therefrom.

Another technique that has been used to avoid the tearing of newly-formed layers of an object under fabrication due to raising of the extraction plate is the use of thin membranes at the base of the tank. For example, the present applicant's U.S. Pat. No. 10,357,919 describes the use of a self-lubricating, transparent, polymer membrane disposed between the base of the tank and the resin. Others have used membranes made of polytetrafluoroethylene (“PTFE”) or similar anti-sticking compounds in such roles. For example, Elsey, U.S. PGPUB 2014/0191442 describes a membrane with an anti-stick surface made from a fluorinated ethylene propylene (FEP) fluoropolymer film. While flexible, such a film is not particularly elastic. Other materials contemplated by Elsey include nylon and mylar, or a laminated membrane having a layer of silicone bonded to a polyester film, with the silicone being the resin-facing side of the membrane and the polyester backing providing some elasticity.

While FEP fluoropolymer membranes do offer good anti-stick properties, they are relatively rigid and, therefore, do not afford much improvement of printing speeds over anti-stick coatings applied directly to vat surfaces. Furthermore, their rigidity can lead to the membrane being damaged during its installation in a vat polymerization printer. Silicone rubber membranes can provide improved flexibility over FEP fluoropolymer membranes, and thereby permit faster overall printing speeds, however, they suffer from susceptibility to wear and tear as they tend to degrade when exposed to high temperatures such as those produced due to the exothermic nature of the polymerization reaction within a printer's vat. They are also porous mediums and may offer little or no resistance to constituent components of some 3D printing resins.

### SUMMARY OF THE INVENTION

In various embodiments, the present invention provides a method for forming three-dimensional objects by photo-curing a photo-curing liquid polymer exposed to a radiation, wherein said three-dimensional objects form by growth, due to the progressive curing of said photo-curing liquid polymer, in a space between a tank base transparent to the radiation and an extraction plate, said extraction plate progressively moving away from said transparent base. The method is characterized in that on a side of said transparent base facing towards said photo-curing liquid polymer a membrane is disposed. The membrane is transparent to said radiation and is supported at its edges by a compliant support structure configured to permit said membrane to be displaced, at least partially in an area beneath said object, vertically in a direction towards said extraction plate in response to said extraction plate being raised from a first positon to a second position, and to return said membrane to an approximate planar orientation after said displacement.

In further embodiments, the present invention provides an apparatus for forming three-dimensional objects by photo-curing a photo-curing liquid polymer through exposure to a radiation, said apparatus including a tank for collecting said photo-curing liquid polymer, a base of the tank that is at least partially transparent to said radiation, and an extraction plate configured to move away from the base of the tank. The apparatus is characterized in that, on a side of said base facing towards said photo-curing liquid polymer, a membrane is disposed, said membrane being transparent to said radiation, and being supported at its edges by a compliant support structure configured to permit said membrane to be displaced, at least partially in an area beneath said object, vertically in a direction towards said extraction plate in response to said extraction plate being raised from a first positon to a second position, and to return said membrane to an approximate planar orientation after said displacement. The base of the tank may, for example be borosilicate glass or quartz and the membrane may, in some cases, be displaced above the base of the tank and separated therefrom by an air gap.

### BRIEF DESCRIPTION OF THE DRAWINGS

The present invention is described, by way of example and without limiting the scope of the invention, with reference to the accompanying drawings which illustrate preferred embodiments of it, in which:

FIG. 1 depicts a schematic cross-section of a 3D printing system for fabricating an object in a tank containing a photo-curing liquid resin having a multi-material membrane, in accordance with an embodiment of the present invention.

FIG. 2 depicts an example of a controller for the 3D printing system illustrated in FIG. 1.

FIG. 3 depicts a perspective view of a membrane assembly for a 3D printing system.

FIGS. 4A-4D illustrate the actions of a compliant support structure for a membrane in accommodating movement of the membrane during printing operations, in accordance with embodiments of the present invention.

FIG. 5 depicts a perspective view of tank sidewall for a 3D printing system.

FIGS. 6A and 6B depict cross-sectional views of a membrane assembly and tank sidewall illustrating the membrane assembly secured to a bottom rim of the tank sidewall.

FIGS. 7A and 7B depict perspective views of a frame assembly and LCD assembly illustrating the frame assembly secured to the LCD assembly.

FIG. 7C depicts a cross-sectional view along line I-I of FIG. 7B.

### DETAILED DESCRIPTION

As discussed above, prior efforts to eliminate the suction effect resulting from a vacuum between the surface of an object being formed and a photopolymerization vat base have involved the use of non-stick coatings on the base and/or the use of a thin membrane made of a non-stick material positioned between the layer being formed and the tank base. Each of these solutions seek to reduce mechanical stresses on newly-formed layers of the object being formed introduced by the raising of a printer extraction plate, thereby allowing the printing process to proceed more rapidly than might otherwise be possible. However, many such membranes formed of non-stick materials are relatively inflexible and can be damaged if the extraction plate is raised or lowered too quickly (e.g., due to strain forces) and/or during insertion and/or cleaning of the membrane.

The present invention provides a solution that allows for the use of thin membranes made from non-stick materials, thereby maintaining the benefits afforded by such membranes, while at the same time allowing for more rapid printing speeds and a reduced risk of damage to the membrane. In particular, the present invention provides a compliant support structure for such a membrane when used in a photopolymerization vat. The compliant support structure may be in the form of a frame that supports and provides bi-lateral strain for the membrane and/or a vat sidewall to which the membrane is attached directly or via a frame. The compliant support structure allows for a membrane that is transparent to an electromagnetic spectrum of interest a the photo-curing process and is made of a relatively inflexible material, such as PTFE, an FEP fluoropolymer, or similar material, to be interposed between the base of a photopolymerization vat and a photo-curing liquid polymer, thereby allowing the photo-curing liquid polymer to solidify under the influence of an incident light. When a layer of an object under fabrication is formed and the extraction plate is raised, the compliant support structure will flex, allowing the membrane to be raised slightly off of the base of the vat due to the suction force created between the membrane and the newly-printed layer. As the extraction plate continues to be raised, the support structure will return to its original shape, causing the membrane to be peeled away from the newly-printed layer by its edges, thereby minimizing the tearing forces on the newly-printed layer. This allows an overall faster printing speed than might otherwise be possible (because the time spent repositioning the extraction plate after printing each layer is reduced) and also helps reduce the risk of damage to the object being printed and the thin membrane.

In accordance with embodiments of the present invention, the membrane is relatively inflexible (although flexible membranes may also be used) and, optionally, may be displaced vertically some distance (e.g., a few microns to a few millimetres) from the base of the tank (which may be a transparent plate of quartz or borosilicate glass). In many cases the membrane is positioned on the base of the tank, but where it is displaced above the base an air gap is introduced between the base of the tank and a bottom surface of the membrane. This air gap may be pressurized, if the space between the membrane and the base of the tank is sealed around its edges, or may be left open (i.e., at atmospheric pressure). The membrane is supported at its edges by a compliant support structure, e.g., a frame, the properties of which allow the frame to flex as the extraction plate is displaced vertically during the printing process. As a result, the thin layer of the object under construction that has just been formed and the membrane do not experience shear and/or peeling forces as great as might otherwise be the case if the relatively inflexible membrane remained flat or nearly so (e.g., adhering to the base of the tank) when the extraction plate was raised. Where present, an air gap between the membrane and the base of the tank may provide for cooling during printing, for example if a cooling fluid or gas is circulated therein.

More specifically, in the absence of the present compliant support structure, as an extraction plate is raised during a printing process, so too is a newly-formed layer of the object under construction. This is because that newly-formed layer adheres to the preceding layers of the object as the liquid polymer cures. The polymer resin is very viscous and there is an absence of air (i.e., a vacuum or partial vacuum) between the newly-formed layer of the object under construction and the membrane. Consequently, as that newly-formed layer rises (as a result of the raising of the extraction plate), the membrane experiences forces drawing it upwards in an area immediately beneath the newly-formed layer. At the same time, if the membrane is placed on the base of the tank and/or is maintained taught above an air gap above the base of the tank, it will resist deformation due to the forces experienced as the extraction plate is raised. Consequently, if the extraction plate and the newly-formed layer are raised too quickly, the membrane and/or the newly-formed layer may tear.

The present compliant support structure for the membrane alleviates this problem by flexing as the newly-formed layer rises (as a result of the raising of the extraction plate) and draws the membrane in an area immediately beneath the newly-formed layer upwards. This flexing relieves the strain experienced by the membrane and the newly-formed layer, allowing the extraction plate to be raised more quickly than might otherwise be the case. As the extraction plate is raised, and the compliant support structure begins to return to its original shape due to its elastic nature, the membrane gradually peels away from the newly-formed layer of the object. This gradual separation of the membrane and the newly-formed layer of the object further reduces mechanical stresses on the newly-formed polymer layer, thereby further reducing the risk of that layer tearing away from the previously-formed portions of the object under construction. Thus, less time is lost to the process of repositioning the extraction plate between printing of layers because there is less stress placed on the newly-formed layer and the membrane during that process and, hence, the extraction plate can be repositioned at greater speed than would otherwise be the case.

As indicated above, the support structure for the membrane flexes because it is made of a material having beneficial elastic properties. After flexing, the support structure will return to its previous orientation in accordance with its elastic properties, returning the membrane to a planar orientation, but will do so gradually such that the peeling of the membrane from the newly-formed layer will not result in tearing of that layer of the object. By allowing the support structure for the membrane to flex in this fashion, the overall printing speeds are increased because the extraction plate can be repositioned more quickly than would otherwise be the case.

A first embodiment of the present invention therefore relates to a method for forming three-dimensional objects by photo-curing a photo-curing liquid polymer exposed to a radiation, wherein said three-dimensional objects form by growth, due to the progressive curing of said photo-curing liquid polymer, in a space between a base transparent to the radiation and an extraction plate, that is, a portion already formed of said objects, said supporting plate progressively moving away from said transparent base, characterized in that on a side of said transparent base facing towards said photo-curing liquid polymer a membrane is disposed above said transparent base, said membrane being transparent to said radiation and supported in a compliant structure that allows the membrane to be displaced from a planar orientation when printing is taking place to one that is non-planar when the extraction plate is being moved vertically with respect to said base, and thereafter returns to an original position (or nearly so) in which it maintains the membrane in the planar orientation. Optionally, an air gap may be present between said flexible membrane and the transparent base of the tank.

A second embodiment of this invention relates to an apparatus for forming three-dimensional objects by photo-curing a photo-curing liquid polymer through exposure to a radiation, said apparatus being of the type including a tank for containing said photo-curing liquid polymer, the base of the tank being a material transparent to said radiation or an LCD panel, and an extraction plate designed to move away from the base of the tank, said apparatus characterized in that, on the side of said base or LCD panel facing towards said photo-curing liquid polymer is positioned a membrane transparent to said radiation, said membrane being supported in a compliant structure that maintains the membrane in a planar orientation when printing is taking place and flexes so as to allow the membrane to first assume a non-planar orientation when the extraction plate is being moved vertically with respect to said base, and to thereafter returns to the planar orientation when the structure returns to its original position (or nearly so). Optionally, the membrane may be displaced above the transparent material and separated therefrom by an air gap.

In one embodiment according to the invention, the membrane is made, at least partially, of PTFE, an FEP fluoropolymer, or similar material.

According to the present invention, the flexible nature of the support structure for the membrane allows two characteristic problems of traditional bottom-up 3D printing systems to be resolved: the detachment of a layer just formed from the tank base and the refreshing of liquid polymer between a layer just formed and a tank base. The liquid polymer, suitably doped with ultraviolet catalysts and, optionally, other substances, remains suspended on the membrane as it cures, not making contact with the base of the tank. Hence, there is no need to effect detaching of the layer which has just been formed by raising the extraction plate in a tilting motion (although such a tilting motion may be used, if desired). Further, the extraction plate can be raised more quickly than would otherwise be the case because the flexible nature of the support structure for the membrane allows for a reduction of mechanical stresses on the still-curing layer and the membrane during the raising of the extraction plate. With regard to refreshing the liquid polymer, as support structure returns to its original position causing the membrane to return to its original planar orientation, polymer resin is drawn into the area from which the membrane retreats; thus providing rapid refreshing of the liquid polymer and alleviating the need for interrupting the extraction process whilst awaiting a refresh.

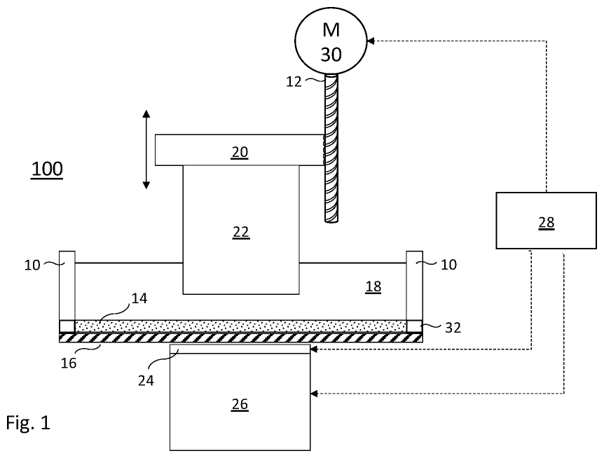

FIG. 1 depicts a cross-section of 3D printing system 100 configured with a thin membrane supported by a compliant structure in accordance with an embodiment of the present invention, in which electromagnetic radiation (e.g., UV light) is used to cure a photo-curing liquid resin (typically a liquid polymer) 18 in order to fabricate an object (e.g., a 3D object) 22. Object 22 is fabricated layer by layer (i.e., a new layer of object 22 is be formed by photo-curing a layer of liquid polymer 18 adjacent to the bottom surface of object 22), and as each new layer is formed the object may be raised by extraction plate 20, allowing a next layer of photo-curing liquid resin 18 to be drawn under the newly formed layer. This process may be repeated multiple times to form additional layers until fabrication of the object is complete.

The 3D printing system 100 includes tank (or vat) 10 for containing the photo-curing liquid resin 18. The bottom of tank 10 (or at least a portion thereof) is sealed to prevent the photo-curing liquid polymer 18 from leaking out of tank 10 and a membrane 14, which is transparent (or nearly so) at wavelengths of interest for curing of the resin to allow electromagnetic radiation from a light source 26 to enter into tank 10 is positioned at the base of the tank. Membrane 14 is supported at its perimeter by a compliant support structure 32. In various embodiments, the compliant support structure may be a frame (as discussed further below) or the sidewalls (e.g., a portion thereof) of tank 10. A mask 24 (e.g., a liquid crystal layer) is disposed between light source 26 and the photo-curing liquid resin 18 to allow the selective curing of the liquid resin (which allows the formation of 3D objects into desired shapes/patterns). In various embodiments, collimation and diffusion elements such as lenses, reflectors, filters, and/or films may be positioned between mask 24 and light source 26. These elements are not shown in the illustrations so as not to unnecessarily obscure the drawing.

A platen or backing member 16 formed of borosilicate glass or other material is disposed between the mask 24 and the membrane 14 and provides structural support. The platen is also transparent (or nearly so) at the one or more wavelengths of interest for curing the resin. In other instances, platen 16 may be metal or plastic and include a transparent window to allow electromagnetic radiation from light source 26 to enter into tank 10. In other embodiments, the mask 24 itself may be used in place of a separate window and its perimeter sealed with a gasket. Note that although the mask 24, platen 16, and membrane 14 are shown as being displaced from one another by some distance, in practice these components may be positioned so as to touch one another, so as to prevent refraction at any air interfaces. Membrane 14 may be secured to the edges of tank 10 or to support structure 32 in the form of a replaceable cartridge assembly so as to maintain a liquid-tight perimeter at the edges of the tank or other opening (“liquid-tight” meaning that the tank does not leak during normal use).

When fabricating a layer of object 22 using 3D printing system 100, electromagnetic radiation is emitted from radiation source 26 through mask 24, platen 16, and membrane 14 into tank 10. The electromagnetic radiation forms an image on an image plane adjacent the bottom of object 22. Areas of high (or moderate) intensity within the image cause curing of localized regions of the photo-curing liquid resin 18. The newly cured layer adheres to the former bottom surface of object 22 and substantially does not adhere to the bottom surface of tank 10 due to the presence of membrane 14. After the newly cured layer has been formed, the emission of electromagnetic radiation may temporarily be suspended (or not, in the case of “continuous printing”) while the extraction plate 20 is raised away from the bottom of the tank so that another new layer of object 22 may be printed.

The extraction plate 20 may be raised and lowered by the action of a motor (M) 30, which drives a lead screw 12 or other arrangement. Rotation of the lead screw 12 due to rotation of the motor shaft causes the extraction plate 20 to be raised or lowered with respect to the bottom of the tank 10. In other embodiments, a linear actuator or other arrangement may be used to raise and lower the extraction plate 20.

In 3D printing system 100, the light source 26 may be an array of light emitting diodes (LEDs), an organic light-emitting diode (OLED) light source, or other light source (e.g., a digital projector of the DLP type). The OLED light source 26 may be referred to by other names, such as an OLED array (inasmuch as the OLED light source 26 is typically formed by an array of LEDs) or an OLED panel. In this latter instance, no separate mask 24 would be necessary inasmuch as an image (i.e., an image of a cross section of the 3D object 22) may be formed within the resin 18 disposed in the tank by turning respective ones of the LEDs of the OLED light source 26 on or off.

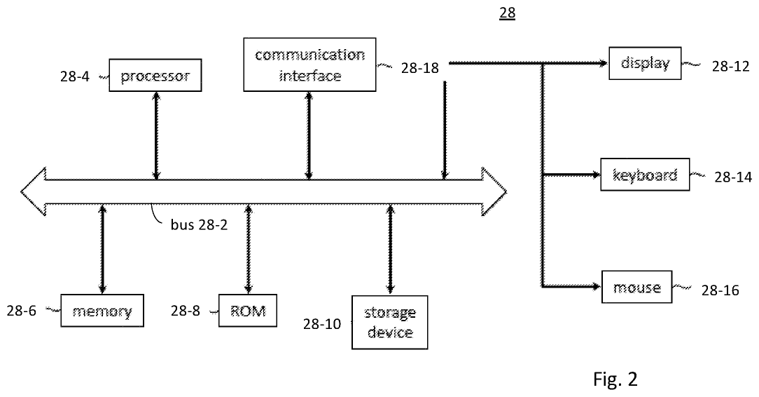

Aspects of the printing process are directed by a controller 28, which may be implemented as a processor-based system with a processor-readable storage medium having processor-executable instructions stored thereon so that when the processor executes those instructions it performs operations to cause the actions described above. For example, among other things controller 28 may instruct raising/lowering of the build plate 20 via motor 30, activation and deactivation of the light source 26, and the projection of cross-sectional images of the object under fabrication via mask 24. FIG. 2 provides an example of such a controller 28, but not all such controllers need have all of the features of controller 28. For example, certain controllers may not include a display inasmuch as the display function may be provided by a client computer communicatively coupled to the controller or a display function may be unnecessary. Such details are not critical to the present invention.

Controller 28 includes a bus 28-2 or other communication mechanism for communicating information, and a processor 28-4 (e.g., a microprocessor) coupled with the bus 28-2 for processing information. Controller 28 also includes a main memory 28-6, such as a random access memory (RAM) or other dynamic storage device, coupled to the bus 28-2 for storing information and instructions (e.g., g-code) to be executed by processor 28-4. Main memory 28-6 also may be used for storing temporary variables or other intermediate information during execution of instructions to be executed by processor 28-4. Controller 28 further includes a read only memory (ROM) 28-8 or other static storage device coupled to the bus 28-2 for storing static information and instructions for the processor 28-4. A storage device 28-10, for example a hard disk, flash memory-based storage medium, or other storage medium from which processor 28-4 can read, is provided and coupled to the bus 28-2 for storing information and instructions (e.g., operating systems, applications programs such as a slicer application, and the like).

Controller 28 may be coupled via the bus 28-2 to a display 28-12, such as a flat panel display, for displaying information to a computer user. An input device 28-14, such as a keyboard including alphanumeric and other keys, may be coupled to the bus 28-2 for communicating information and command selections to the processor 28-4. Another type of user input device is cursor control device 28-16, such as a mouse, a trackpad, or similar input device for communicating direction information and command selections to processor 28-4 and for controlling cursor movement on the display 28-12. Other user interface devices, such as microphones, speakers, etc. are not shown in detail but may be involved with the receipt of user input and/or presentation of output.

Controller 28 also includes a communication interface 28-18 coupled to the bus 28-2. Communication interface 28-18 may provide a two-way data communication channel with a computer network, which provides connectivity to and among the various computer systems discussed above. For example, communication interface 28-18 may be a local area network (LAN) card to provide a data communication connection to a compatible LAN, which itself is communicatively coupled to the Internet through one or more Internet service provider networks. The precise details of such communication paths are not critical to the present invention. What is important is that controller 28 can send and receive messages and data, e.g., a digital file representing 3D articles to be produced using printer 100 through the communication interface 28-18 and in that way communicate with hosts accessible via the Internet. It is noted that the components of controller 28 may be located in a single device or located in a plurality of physically and/or geographically distributed devices.

Returning to FIG. 1, in some embodiments, the membrane 14 may be displaced a distance from platen 16 by an air gap (e.g., in various embodiments, an air gap of a few micrometers to a few millimeters, for example 20 μm to 2 mm). In other embodiments of the invention, the membrane 14 is allowed to rest on platen 16.

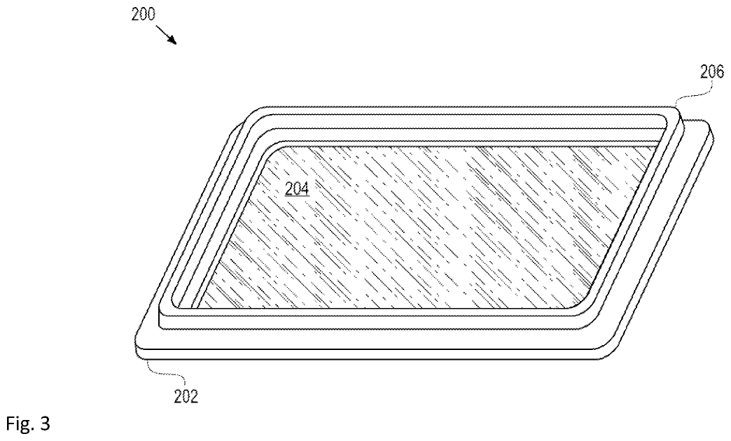

As mentioned above, the membrane may be part of a replaceable cartridge assembly. FIG. 3 depicts a perspective view of a membrane assembly 200 for a 3D printing system in accordance with an embodiment of the present invention. Membrane assembly 200 may include radiation-transparent membrane 204, the perimeter of which is secured to a compliant frame 202. Frame 202 may be configured to stretch membrane 204 along a first plane parallel to extent of the frame 202. Frame 202 may comprise lip 206 that extends in a direction perpendicular to the first plane. Lip 206 may be secured to a bottom rim of a tank sidewall (as discussed below). Membrane assembly 200, when secured to the bottom rim of the tank sidewall, forms a bottom of a tank configured to contain a photo-curing liquid resin. In FIG. 3, frame 202 is depicted to have a rectangular shape, however, other shapes for frame 202 are possible, including square, oval, circular, etc.

Frame 202 is constructed, at least partially, of a compliant material such that it retains the essentially planar orientation of membrane 204 during printing operations when the resin is being exposed to light for curing of a layer. Following the curing of a layer, when the extraction plate is raised, the suction forces acting on membrane 204 cause membrane 204 to be lifted from its position resting on (or above) the platen in an area beneath the newly-formed layer of the object being printed. Because frame 202 is made, at least partially, of a compliant material, the edges of the frame flexed to accommodate this lifting of membrane 204, thereby relieving stain within the plane of the membrane and reducing the risk of tearing of the membrane. Frame 202 thus allows membrane 204 to be displaced, at least in part, from its original planar orientation when printing is taking place to one that is non-planar when the extraction plate is being moved vertically with respect to the base of the tank. Thereafter, because of its elastic nature, frame 202 returns to its original shape (position), (or nearly so) in which it maintains membrane 204 in the planar orientation.

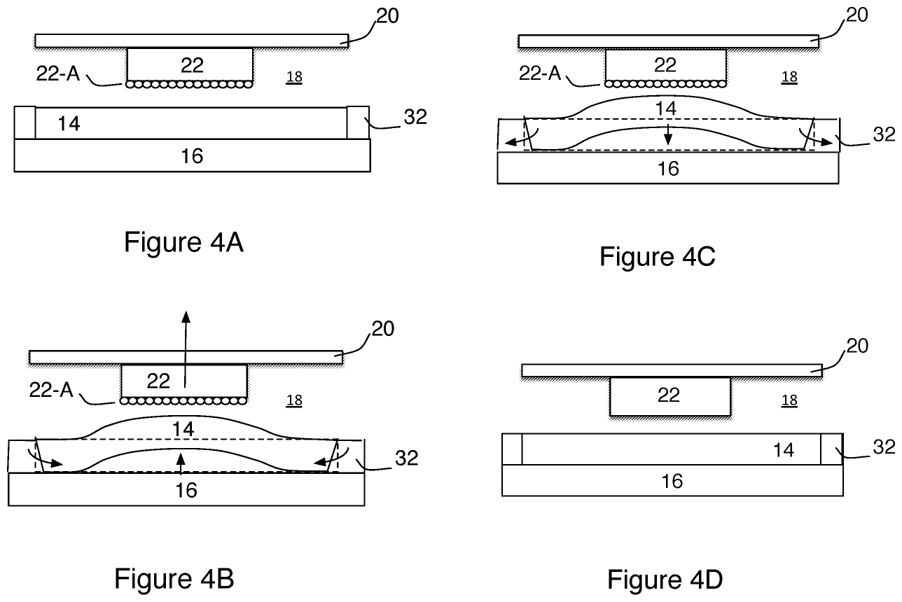

FIGS. 4A-4C illustrate this process in greater detail. As the extraction plate 20 is raised from an initial position (FIG. 4A) during the printing process, a position corresponding to layer 22-A of object 22 being formed, to a new position (FIG. 4B) displaced vertically from the initial position by a distance of typically a few microns to a few millimetres, this displacement causes the membrane 14 to be pulled upward, in the direction of the displacement of the extraction plate, in a region disposed beneath the newly formed layer 22-A. This is because the polymer resin 18 in the region between layer 22-A and membrane 14 is very viscous, and there is an absence of air (i.e., a vacuum) between newly-formed layer and the membrane. Consequently, there is a suction effect between the newly-formed layer 22-A and membrane 14 such that, as the newly-formed layer 22-A rises as a result of the raising of the extraction plate 20, membrane 14 is drawn upwards in an area immediately beneath newly-formed layer 22-A. The degree of deformation of membrane 13 depends on its composition, thickness, and modulus of elasticity.

To accommodate this deformation of membrane 14, support structure 32 (e.g., frame 204) flexes. This flexing allows the membrane, which itself is relative inflexible, to deform without tearing and without remaining adhered to platen 16, which may result in tearing of the newly-formed layer 22-A. The degree to which support structure 32 flexes depends on its construction, composition, thickness, and modulus of elasticity. Examples of materials from which support structure 32 may be made include polylactic acid (PLA), thermoplastic starch (TPS), combinations of PLA and TPS, other thermoplastic elastomers and/or fluoroelastomers such as Viton™ (also known as synthetic rubber), thermoplastic polyolefins (TPO), thermoplastic polyurethanes (TPU), thermoplastic copolyester (TPC), thermoplastic polyamides (TPA), and similar materials.

As the extraction plate 20 and the newly-formed layer 22-A continue to rise and then come to rest at the next printing position (FIG. 4C), the support structure 32, as a consequence of its elastic nature, gradually returns to its original orientation. This gradual rebound of the support structure 32 causes membrane 14 to be returned to its original planar orientation, away the newly-formed layer 22-A of the object 22. But, this return of the membrane to its original orientation and position is such that it puts only limited mechanical stresses on the newly-formed polymer layer 22-A, thereby reducing the risk of that layer tearing away from the previously-formed portions of the object 22 under construction. Once the membrane 14 has returned to its original position (FIG. 4D), printing of the next layer can commence. By this time, layer 22-A has fully cured and is an integral part of object 22. Because of the reduction of mechanical stresses on layer 22-A and membrane 14, the overall printing process can proceed at a faster rate than would be the case. That is, less time is lost to the process of repositioning the extraction plate 20 between printing of successive layers because there is less stress placed on each newly-formed layer and on the membrane during that process.

Use of a compliant support structure for the membrane, in accordance with embodiments of the present invention, also provides for replenishing photo-curing liquid polymer within an area of the tank in which photo-curing liquid polymer has been cured, thereby forming a new layer of the three-dimensional object under fabrication. For example, as a new layer is formed and the extraction plate on which the object is being fabricated is raised, the membrane positioned below the object (or at least a portion of the membrane) is displaced above the base of the tank in the direction of motion of the extraction plate, as described above. Thereafter, due to the elastic nature of the supporting structure for the membrane, the membrane will be returned to an approximately planar orientation above the base of the tank, and in doing so will draw a volume of the photo-curing liquid polymer into the space between the membrane and the object. The liquid polymer is very viscous. Therefore, the rate at which the liquid polymer will be drawn into the space between the membrane and the object undergoing fabrication by virtue of the vacuum or partial vacuum created by the return to a planar orientation of the membrane is faster than that which would otherwise occur.

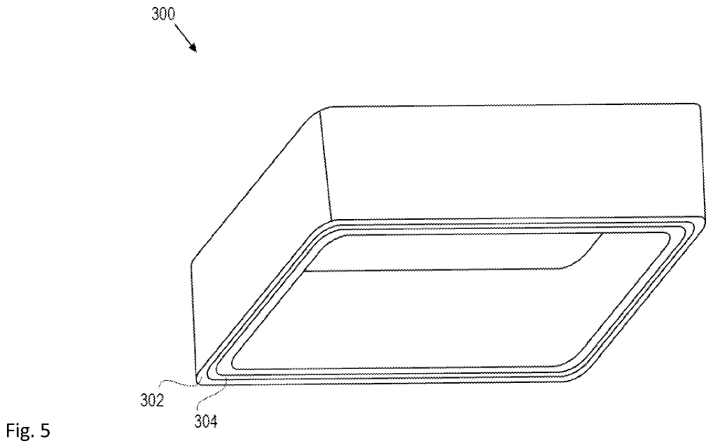

FIG. 5 depicts a perspective view of tank sidewall 300 for a 3D printing system. The tank sidewall 300 includes bottom rim 302 with groove 304. Lip 206 of frame 202 may be inserted within groove 304 so as to secure membrane assembly 200 onto the base of tank sidewall 300. The shape and dimensions of tank sidewall 300 must match the shape and dimensions of frame 202. For instance, if frame 202 were rectangular, a tank sidewall 300 must also be rectangular (i.e., when viewed from above).

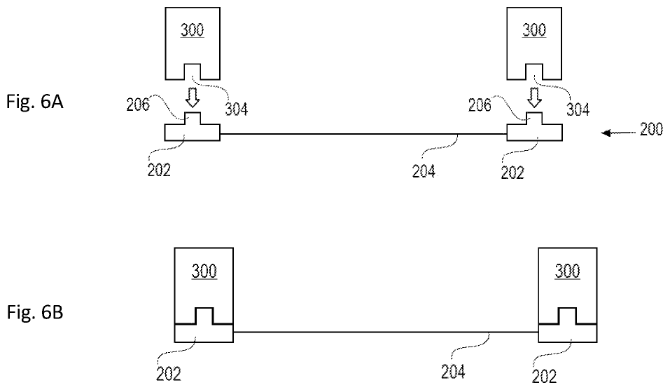

FIGS. 6A and 6B depict cross-sectional views of membrane assembly 200 (with frame 202 and membrane 204) and tank sidewall 300 and show how membrane assembly 200 is secured to bottom rim 302 of tank sidewall 300. FIG. 6A depicts lip 206 of frame 202 aligned under groove 304 of tank sidewall 300. FIG. 6B depicts lip 206 of frame 202 inserted within groove 304 of tank sidewall 300. Lip 206 and groove 304 may interlock with one another (e.g., in a snap-fit attachment), may snugly fit so that surfaces of lip 206 and groove 304 contact one another (e.g., in a friction-fit attachment), etc. In one embodiment, membrane assembly 200 may be a “consumable” product, in that it is disposed of or refurbished at the end of its useful lifetime. As such, membrane assembly 200 may play a similar role as printer cartridges in a printer; razor blades in a razor; etc.

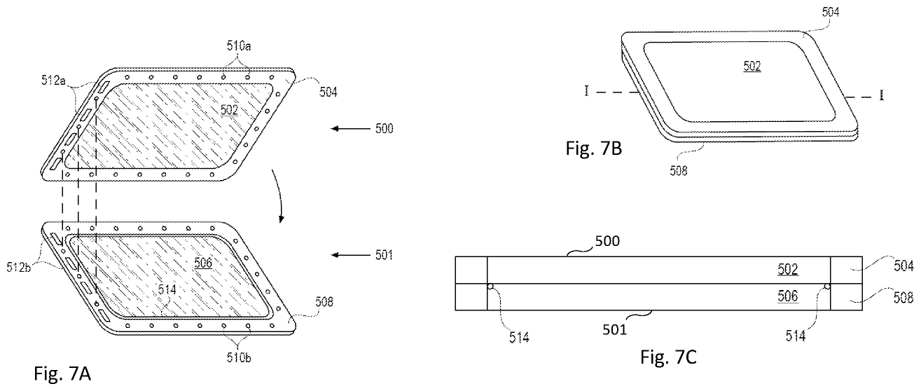

FIGS. 7A and 7B depict perspective views of a frame assembly 500 and LCD assembly 501, showing how frame assembly 500 may be secured to LCD assembly 501. Frame assembly 500 may include compliant frame 504 and radiation-transparent membrane 502, with compliant frame 504 configured to hold membrane 502 at its perimeter. In other embodiments, the frame assembly 500 may support both membrane 502 and a transparent glass plate. Frame 504 may include through holes 510a and magnetized portions 512a distributed about a bottom surface of frame 504. LCD assembly 501 may include frame 508 and LCD 506, in which frame 508 is configured to hold LCD 506. Frame 506 may include through holes 510b and magnetized portions 512b distributed about a top surface of frame 508.

As depicted in FIG. 7A, a pattern in which through holes 510a are distributed about the bottom surface of frame 504 may be a mirror image of a pattern in which through holes 510b are distributed about the top surface of frame 508. As further depicted in FIG. 7A, a pattern in which magnetized portions 512a are distributed about the bottom surface of the frame 504 may be a mirror image of a pattern in which magnetized portions 512b are distributed about the top surface of frame 508. Each one of magnetized portions 512a may be attracted to a corresponding one of magnetized portions 512b such that when frame 504 is disposed in proximity to frame 508, the bottom surface of the frame 504 automatically contacts the top surface of frame 508, and each one of the through holes 510a automatically aligns with a corresponding one of through holes 510b. Gasket 514 may be disposed at or near a perimeter of LCD 506. The purpose of gasket 514 will be explained below with respect to FIG. 7C.

FIG. 7B depicts a perspective view of frame 504 affixed to LCD frame 508. Frame 504 surrounds radiation-transparent membrane 502 and (optionally) a glass plate. LCD 506 is not visible in FIG. 5B but is located directly beneath membrane 502. Small screws or pins may be inserted through aligned pairs of through holes 510a and 510b to secure this arrangement. Openings for such screws or pins may be located in a bottom surface of frame 508 (not depicted).

FIG. 7C depicts a cross-sectional view along line I-I of FIG. 7B. As shown in FIG. 7C, frame assembly 500 is affixed to the LCD assembly 501. More particularly, a bottom surface of frame 504 contacts a top surface of frame 508, and membrane 502 is disposed above LCD 506. Gasket 514 is disposed within or near a boundary region between the bottom surface of frame 504 and the top surface of frame 508. In the event that resin (or another fluid) is able to penetrate the boundary region between the bottom surface of frame 504 and the top surface of frame 508, gasket 514 may prevent the resin from flowing between LCD 506 and membrane 502 (which may lead to undesirable distortion in images projected from LCD 506).

As described above, magnets (or magnetized portions of the frames) may be used to automatically align through holes 510a with through holes 510b. In addition or alternatively, grooves (e.g., saw tooth grooves) disposed on both the bottom surface of frame 504 and the top surface of frame 508 (and particularly grooves in the bottom surface that are complementary to grooves in the top surface,) may also be used as a self-alignment mechanism.

The portion of frame assembly 500 securing membrane 502 is a compliant portion that permits the movement of membrane 502 discussed above. Other portions of frame assembly 500 may be rigid portions, so as to restrict or prevent movement of the frame assembly with respect to the tank sidewalls, LCD assembly 501, and/or an optional glass plate.

In some cases, the membrane may be secured directly to the tank sidewalls without the use of a separate frame. In such cases, the compliant supporting structure for the membrane may be a portion of the tank sidewall. Such a compliant portion of the tank sidewall may be an inner portion thereof located near the bottom of the tank, with an outer portion of the sidewall remaining rigid so as to prevent undue deformation of the tank sidewall and/or leaking of the resin from the tank due to a poor seal with the base of the tank. In some cases, the compliant section of the tank sidewall may be separated from the rigid portion thereof by a gasket, so as to reduce the change of resin leakage.

In the various embodiments described herein, where present, an air gap (pressurized or not) may be provided in the space between the membrane and the base of the tank. If the air gap is pressurized, air or a noble gas may be used. Alternatively, the air gap may be left unsealed and may remain at atmospheric pressure.

Whether or not an air gap is present, the flexing of the support structure for the membrane when the extraction plate is raised means that a thin, newly-formed layer of an object under construction will not experience shear and/or peeling forces as great as it otherwise would if the compliant support structure were not present.

Thus, a compliant support structure for a substratum (e.g., a membrane) used in a photopolymerization vat for 3D printing of articles by means of photo-curing photo-sensitive materials has been described.

1. A method for forming a three-dimensional object by photo-curing a photo-curing liquid polymer exposed to a radiation, wherein said three-dimensional object forms by growth, due to the photo-curing of said photo-curing liquid polymer, in a space between a tank base transparent to the radiation and an extraction plate, said extraction plate progressively moving away from said transparent tank base, wherein on a side of said transparent tank base facing towards said photo-curing liquid polymer, a membrane is disposed, said membrane being transparent to said radiation and supported at its edges by a compliant support structure configured to permit said membrane to be displaced, at least partially in an area beneath said object, vertically in a direction towards said extraction plate in response to said extraction plate being raised from a first position to a second position, and to return said membrane to an approximate planar orientation after said displacement, and wherein the compliant support structure flexes in response to the vertical displacement of said membrane.

2. An apparatus for forming a three-dimensional object by photo-curing a photo-curing liquid polymer through exposure to a radiation, said apparatus including a tank for collecting said photo-curing liquid polymer, a base of the tank that is at least partially transparent to said radiation, and an extraction plate configured to move away from the base of the tank, wherein on a side of said base facing towards said photo-curing liquid polymer, a membrane is disposed, said membrane being transparent to said radiation, and being supported at its edges by a compliant support structure configured to permit said membrane to be displaced, at least partially in an area beneath said object, vertically in a direction towards said extraction plate in response to said extraction plate being raised from a first position to a second position, and to return said membrane to an approximate planar orientation after said displacement, and wherein the compliant support structure is configured to flex in response to the vertical displacement of said membrane.

3. The apparatus of claim 2, wherein the base of the tank comprises borosilicate glass or quartz.

4. The apparatus of claim 2, wherein said membrane is displaced above the base of the tank and is separated therefrom by an air gap.
